(19) United States
(12) Patent Application Publication
(10) Pub. No.: US 2017/0300041 A1
(43) Pub. Date: Oct. 19, 2017

(54) PRODUCTION SYSTEM FOR EXECUTING PRODUCTION PLAN

(71) Applicant: FANUC CORPORATION, Yamanashi (JP)

(72) Inventors: Yasushi ONISHI, Yamanashi (JP); Yuuki OONISHI, Yamanashi (JP)

(21) Appl. No.: 15/485,308

(22) Filed: Apr. 12, 2017

(30) Foreign Application Priority Data
Apr. 15, 2016 (JP) 2016-082284

(51) Int. Cl. G05B 19/4155; G06N 99/00

(52) U.S. Cl. CPC G05B 19/4155; G06N 99/005; G05B 2219/31427

(57) ABSTRACT

A failure of a machine or the like is rapidly detected to efficiently operate the machine. A cell control device of a production system includes a product information monitoring unit for monitoring the product information, a component supply state monitoring unit for monitoring plural kinds of components to be supplied to at least one cell and the number of each kind of components, and a notification unit which transmits a notice to a higher-level management controller when the number of each kind of components, which is monitored by the component supply state monitoring unit, deviates from a predetermined range determined for each kind of components.

### BACKGROUND OF THE INVENTION

### 1. Field of the Invention

The present invention relates to a production system for executing a production plan made in a higher-level management controller.

### 2. Description of the Related Art

Conventionally, in an assembly line, plural kinds of and a number of components are handled to produce a product. FIG. 8 is a block diagram of a production system in a prior art. In FIG. 8, a cell 400 includes a plurality of machines R1 and R2, a plurality of machine control devices RC1 and RC2 for controlling the machines R1 and R2. In the cell 400, the machines R1 and R2 produce products independently or in cooperation with each other. A higher-level management controller 200 as a production planning device is communicably connected to the cell 400 by a communication unit 410.

In this respect, the kind of components necessary to produce one product and the number of the components are included, as product information S0, in the higher-level management controller 200. The higher-level management controller 200 causes plural kinds of components, the number of which is determined in accordance with the product information S0, to be supplied to the cell 400.

Further, Japanese Unexamined Patent Publication (Kokai) No. 2013-016087 discloses that the production planning device improves the productivity based on information regarding the stock of plural kinds of components and the number of components.

### SUMMARY OF THE INVENTION

In the production system shown in FIG. 8, when the machines R1 and R2 of the cell 400 break down, or an operator erroneously operates the higher-level management controller 200, products are not produced in accordance with the production plan set in the higher-level management controller 200 in some cases.

Specific examples are as follows.

(1) The production capability remarkably reduces because of a failure in at least one of the machines R1 and R2.

(2) The higher-level management controller 200 has a wide supervision area, but has less responsiveness. Thus, there is a delay in supply of components, and accordingly, the machines R1 and R2 reach a standby condition and then time loss occurs. In this instance, products cannot be suitably produced.

(3) There is an error in input to the higher-level management controller 200, and an excess or deficiency occurs in supply of components.

When these problems are not rapidly detected, the production efficiency of the production system reduces as the time passes. Note that Japanese Unexamined Patent Publication (Kokai) No. 2013-016087 does not disclose that the aforementioned problems are rapidly detected.

The present invention was made in light of the circumstances described above and has an object to provide a production system which can rapidly detect, for example, a failure of a machine, to efficiently operate the machine.

To achieve the above object, according to a first aspect of the invention, there is provided a production system includes at least one cell including a plurality of machines for producing products, and a plurality of machine control devices for controlling the plurality of machines, a cell control device which is communicably connected to the at least one cell, to control the cell, and a higher-level management controller which is communicably connected to the cell control device and which includes product information. The product information includes plural kinds of components to produce each product and the number of each kind of components. The cell control device includes a product information monitoring unit for monitoring the product information, a component supply state monitoring unit for monitoring the plural kinds of components to be supplied to the at least one cell and the number of each kind of components, and a notification unit which transmits a notice to the higher-level management controller when the number of each kind of components, which is monitored by the component supply state monitoring unit, deviates from a predetermined range determined for each kind of components.

According to a second aspect of the invention, in the production system according to the first aspect of the invention, the cell control device includes a product monitoring unit for monitoring the number of the products actually produced in the cell. When the number of the products to be produced in the cell, which is determined in accordance with the number of the plural kinds of components and each kind of components, which are monitored by the component supply state monitoring unit, is less than the number of the products which are monitored by the product monitoring unit and which are actually produced in the cell, the notification unit transmits a notice to the higher-level management controller.

According to a third aspect of the invention, in the production system according to the first aspect of the invention, the cell control device includes a product monitoring unit for monitoring the number of the products actually produced in the cell. When the number of the products to be produced in the cell, which is determined in accordance with the number of the plural kinds of components and each kind of components, which are monitored by the component supply state monitoring unit, is equal to the number of the products which are monitored by the product monitoring unit and which are actually produced in the cell, and the number of the products to be produced in the cell is less than the desired number of the products, the notification unit transmits a notice to the higher-level management controller.

According to a fourth aspect of the invention, in the production system according to any of the first to third aspects of the invention, the production system includes a machine learning device for learning production data of the production system. The machine learning device includes a state quantity observation unit for observing the state quantity of the production system, an operation result acquisition unit for acquiring a production result of each product in the production system, a learning unit which receives an output from the state quantity observation unit and an output from the operation result acquisition unit, to learn the production data in association with the state quantity of the production system and the production result, and a decision-making unit which outputs production data with reference to the production data learned by the machine learning device.

According to a fifth aspect of the invention, in the production system according to the fourth aspect of the invention, the cell control device includes a product monitoring unit for monitoring the number of the products actually produced in the cell. The state quantity observed by the state quantity observation unit includes at least one of the desired number of products, the product information monitored by the product information monitoring unit, the number of the plural kinds of components and each kind of components monitored by the component supply state monitoring unit, the number of the products which are monitored by the product monitoring unit and which are actually produced, and settings for the plurality of machines included in the cell.

According to a sixth aspect of the invention, in the production system according to the fourth or fifth aspect of the invention, the production data output by the decision-making unit includes at least one of the number of each kind of components to be supplied to the at least one cell and the settings for the plurality of machines included in the at least one cell.

According to a seventh aspect of the invention, in the machine learning device according to the fourth aspect of the invention, the machine learning device includes a learning model for learning production data, an error calculation unit for calculating an error between the production result acquired by the operation result acquisition unit and a predetermined target, and a learning model update unit for updating the learning model in accordance with the error.

According to an eighth aspect of the invention, in the machine learning device according to the fourth aspect of the invention, the machine learning device has a value function for determining the value of production data. the machine learning device further includes a reward calculation unit which provides a plus reward in accordance with a difference between the production result acquired by the operation result acquisition unit and a predetermined target when the difference is small, and provides a minus reward in accordance with the difference when the difference is large, and a value function update unit for updating the value function in accordance with the reward.

These objects, features, and advantages of the present invention and other objects, features, and advantages will become further clearer from the detailed description of typical embodiments illustrated in the appended drawings.

### BRIEF DESCRIPTION OF THE DRAWINGS

FIG. 1 is a block diagram of a production system based on the present invention.

FIG. 2 is a view of an example of product information.

FIG. 3 is a flowchart of the operation of the production system based on the present invention.

FIG. 4 is a view of an example of a machine learning device.

FIG. 5 is a view of another example of the machine learning device.

FIG. 6 is a schematic diagram of a neuron model.

FIG. 7 is a schematic diagram of a three-layer neural network configured by combining neurons shown in FIG. 6.

FIG. 8 is a block diagram of a production system in a prior art.

### DETAILED DESCRIPTION

Embodiments of the present invention will be described below with reference to the accompanying drawings. In the following figures, similar members are designated with the same reference numerals. These figures are properly modified in scale to assist the understanding thereof.

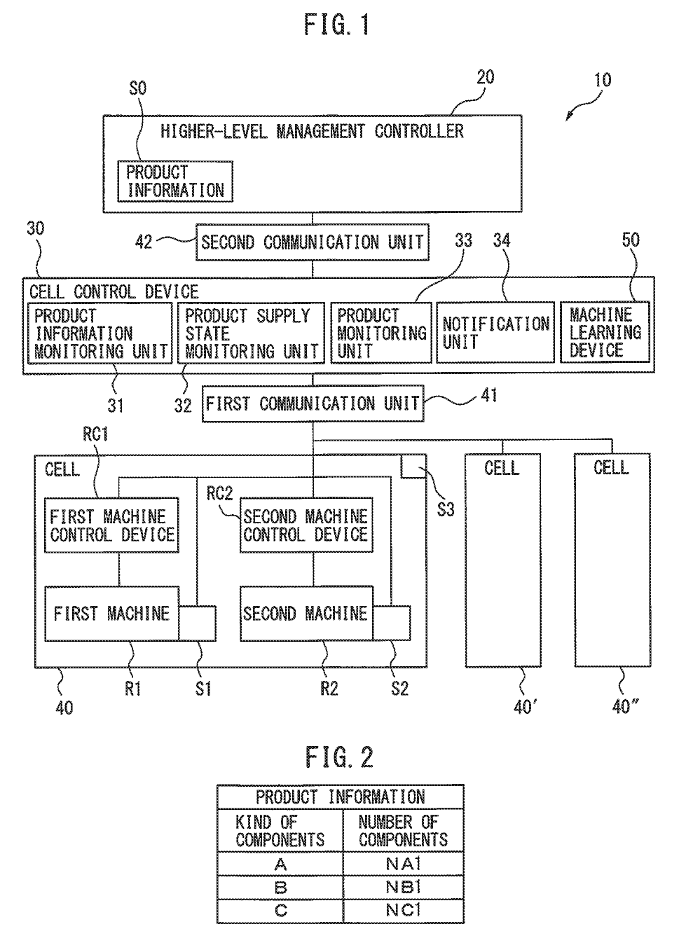

FIG. 1 is a block diagram of a production system based on the present invention. A production system 10 is provided with a cell 40 including at least one, preferably, a plurality of machines (two machines in the illustrated example) R1 and R2 and one or more machine control devices (numerical control devices) RC1 and RC2 (the number of which is usually equal to the number of the machines) for controlling the machines R1 and R2, a cell control device (cell controller) 30 configured to communicate with the machine control devices RC1 and RC2, and a higher-level management controller 20 as a production planning device, which is configured to communicate with a cell control device 30. The machines R1 and R2 make products from plural kinds of components independently or in cooperation with each other. The machine control devices RC1 and RC2 respectively control the machines R1 and R2, and transmit data measured in the machines to the cell control device 30.

The cell 40 is a set of a plurality of machines for performing predetermined operations. Examples of the machines R1 and R2 include machine tools, articulated robots, parallel link robots, manufacturing machines, industrial machines, etc. The machines may be comprised of the same kind of machines, or different kinds of machines. Further, cells 40′ and 40″ having similar configurations are connected to the cell control device 30.

In FIG. 1, sensors S1 and S2 are respectively attached to the machines R1 and R2. The sensors S1 and S2 detect at least one of the speed, the acceleration and deceleration, and the times for acceleration and deceleration of the machines R1 and R2. In addition, the cell 40 is provided with a sensor S3 for detecting various qualities of the produced products.

Note that, in the present invention, the cells 40, 40′, and 40″ can be installed in, for example, a factory for manufacturing products, whereas the cell control device 30 and the higher-level management controller 20 can be installed in, for example, a building different from the factory. In this instance, the cell control device 30 and the machine control devices RC1 and RC2 can be connected via a network, such as an intranet (first communication unit 41). The higher-level management controller 20 can be installed in, for example, an office away from the factory. In this instance, the higher-level management controller 20 can be communicably connected to the cell control device 30 via a network, such as the Internet (second communication unit 42). However, this is merely an example. Any communication unit, which communicably connects the cell control device 30 and the machine control devices RC1 and RC2, can be adopted as the first communication unit 41. Any communication unit, which can communicably connect the cell control device 30 and the higher-level management controller 20, can be adopted as the second communication unit 42.

The higher-level management controller 20 is, for example, a personal computer, and functions as a production planning device which makes a production plan for the system 10 and transmits the same to the cell control device 30. As shown in FIG. 1, the higher-level management controller 20 includes product information S0.

FIG. 2 is a view of an example of the product information S0. The product information S0 expresses the kind of components necessary to produce one product and the number of the components in the form of a map. In an example shown in FIG. 2, one product is composed of three kinds of components A to C. Further, NA0 pieces of the component A, NB0 pieces of the component B, and NC0 pieces of the component C are used to produce one product.

An operator uses, for example, an input unit to input the desired number N0 of products to the higher-level management controller 20. The higher-level management controller 20 controls the supply of plural kinds of the components A to C to the cells 40, 40′, and 40″ based on the feedback from the cell control device 30 and the desired number N0 of products. Note that the product information S0 may include the desired number N0 of products.

The cell control device 30 is configured to control the cells 40, 40′, and 40″. Specifically, the cell control device 30 can transmit plural kinds of commands to the machine control devices RC1 and RC2, or can acquire data regarding, for example, the operating condition of the machines R1 and R2, from the machine control devices RC1 and RC2.

As shown in FIG. 1, the cell control device 30 includes a product information monitoring unit 31 for monitoring the product information S0, a component supply state monitoring unit 32 for monitoring plural kinds of components to be supplied to the cell 40 etc. and the number of the components, a product monitoring unit 33 for monitoring the number of products which are actually produced in the cells 40, 40′, and 40″. Further, the cell control device 30 includes a notification unit 34 which conveys, when a predetermined event occurs, information regarding the event to the higher-level management controller 20 as a problem. The cell control device 30 also includes a machine learning device 50 that will be described later. The machine learning device 50 may be included in the higher-level management controller 20. The machine learning device 50 may also be connected, as an external device, to the cell control device 30 or the higher-level management controller 20.

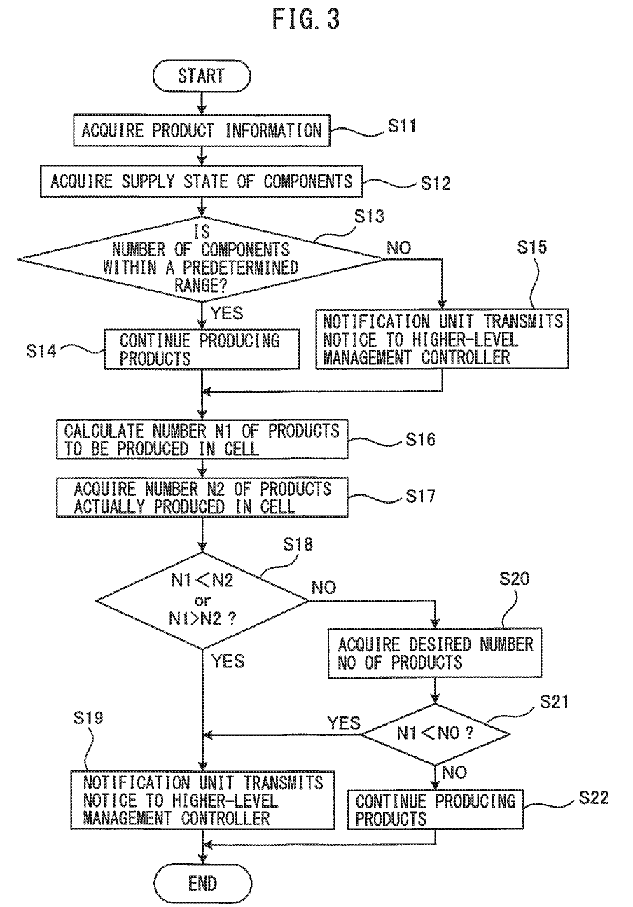

FIG. 3 is a flowchart of the operation of a production system based on the present invention. The operation of the production system 10 will be described below with reference to the drawings. The operations shown in FIG. 3 are repeatedly performed at every predetermined control period when the production system 10 operates. Note that, in the following examples, for the sake of simplicity, products are produced in only the cell 40. Note that substantially similar control is performed in the cells 40′ and 40″.

First, in step S11, the product information monitoring unit 31 of the cell control device 30 acquires the product information S0 and the desired number N0 of products in the higher-level management controller 20. Subsequently, in step S12, the component supply state monitoring unit 32 of the cell control device 30 monitors the supply state of the components A to C. In other words, the component supply state monitoring unit 32 acquires plural kinds of the components A to C to be supplied to the cell 40 and the numbers NA1, NB1, and NC1 of the components A to C.

Subsequently, in step S13, whether each of the components A to C is appropriately supplied to the cell 40 is determined. For each of the components A to C, the maximum number and the minimum number of the components to be appropriately processed in the cell 40 are set. In step S13, whether the numbers NA1 to NC1 of the components A to C are remained between the corresponding maximum and minimum numbers is determined.

When, for example, the number NA1 of the component A is greater than the corresponding maximum number, or is less than the corresponding minimum number, the process shifts to step S15. In step S15, the fact that the number of the supplied components A is too much or not enough is determined, and the notification unit 34 transmits this state to the higher-level management controller 20. The other components B and C are processed in a similar manner.

As described above, in order to produce one product, all the plural kinds of the components A to C are necessary. Thus, when the fact that the number of at least one kind of components among the plural kinds of the components A to C is too much or not enough is determined, it is not possible to successfully produce the products, and the notification unit 34 transmits this information to the higher-level management controller 20.

In such a case, the higher-level management controller 20 causes the too much or not enough number of the components A to C to be increased or decreased by, for example, only a predetermined number. Thus, the production system 10 can be efficiently operated.

Note that, when the fact that the numbers NA1 to NC1 of the components A to C are remained between the corresponding maximum numbers and the corresponding minimum numbers is determined in step S13, the fact that products can be appropriately produced using the components A to C can be determined. Thus, in this instance, the process shifts to step S14, to continue producing products.

Subsequently, in step S16, the number N1 of products to be produced in the cell 40 is calculated. The number N1 of products to be produced in the cell 40 is determined in accordance with the product information S0 acquired in step S11 and the numbers NA1 to NC1 of the components A to C acquired in step S12.

Subsequently, in step S17, the product monitoring unit 33 of the cell control device 30 acquires the number N2 of products actually produced in the cell 40. Further, in step S18, whether the number N1 of products to be produced in the cell 40 is less than the number N2 of products actually produced and whether the number N1 of products to be produced in the cell 40 is greater than the number N2 of products actually produced are determined.

When the fact that the number N1 of products to be produced in the cell 40 is less than the number N2 of products actually produced is determined in step S18, the fact that at least one of the machines R1 and R2 in the cell 40 breaks down can be determined. Thus, the notification unit 34 transmits, in step S19, this information to the higher-level management controller 20. Subsequently, the higher-level management controller 20 causes, for example, the number of plural kinds of components to be decreased by the same ratio. This causes the production system 10 to efficiently operate.

Realistically, there is no possibility that the number N1 of products to be produced in the cell 40 is greater than the number N2 of products actually produced. Thus, when the aforementioned fact is determined in step S18, the notification unit 34 transmits the possibility that an abnormality may occur in the cell 40, to the higher-level management controller 20 (step S19).

In the meantime, when the fact that the number N1 of products to be produced in the cell 40 is equal to the number N2 of products actually produced is determined in step S18, the fact that no abnormality occurs in the cell 40 can be determined. In such a case, the desired number N0 of products is acquired in step S20, and whether the number N1 of products to be produced in the cell 40 is less than the desired number N0 of products is determined in step S21. Note that the operation in step S20 can be omitted.

When the number N1 of products to be produced in the cell 40 is equal to the number N2 of products actually produced, but the number N1 of products to be produced in the cell 40 is less than the desired number N0 of products, the fact that the number of the components A to C to be supplied to the cell 40 is small can be determined. This causes the notification unit 34 to transmit this information to the higher-level management controller 20. Subsequently, the higher-level management controller 20 causes the number of plural kinds of the components A to C to be increased by, for example, a predetermined ratio. This causes the production system 10 to efficiently operate.

As seen above, the cell control device 30 according to the present invention uses the product information monitoring unit 31, the component supply state monitoring unit 32, and the product monitoring unit 33, to acquire various pieces of information from the higher-level management controller 20 and the cell 40. Further, the cell control device 30 determines whether an abnormality occurs, based on various pieces of information, and transmits, when an abnormality occurs, the occurrence of the abnormality to the higher-level management controller 20. This rapidly eliminates the abnormality in the present invention, and accordingly, causes the production system 10 to efficiently operate.

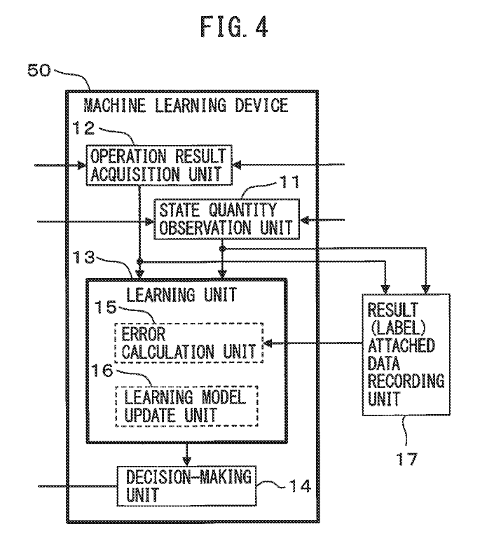

FIG. 4 is a view of an example of a machine learning device. In the present invention, the information obtained from the product information monitoring unit 31, the component supply state monitoring unit 32, and the product monitoring unit 33 is used to cause the machine learning device 50 to learn. The machine learning device 50 is provided with a state quantity observation unit 11, an operation result acquisition unit 12, a learning unit 13, and a decision-making unit 14.

The learning unit 13 of the machine learning device 50 receives an output from the state quantity observation unit 11 for observing the state quantity of the production system 10 and an output (production result of a product) from the operation result acquisition unit 12 for acquiring a processing result in the production system 10, to learn production data in association with the state quantity of the production system 10 and the production result. The decision-making unit 14 decides production data with reference to the production data learned by the learning unit 13, and outputs the same to the cell control device 30.

In this respect, the state quantity observed by the state quantity observation unit 11 includes at least one of the desired number N0 of products, the product information S0 monitored by the product information monitoring unit 31, plural kinds of the components A to C and the numbers NA1 to NC1 of the components, which are monitored by the component supply state monitoring unit 32, the number N2 of products actually produced, which is monitored by the product monitoring unit 33, and settings for the machines R1 and R2 monitored by the product monitoring unit 33. Note that the settings for the machines R1 and R2 include, for example, the operation speed, the acceleration and deceleration, and the times for acceleration and deceleration of the machines R1 and R2.

Further, the production data output by the decision-making unit 14 include the numbers NA2 to NC2 of the plural kinds of components to be supplied to at least one cell 40 and/or the settings for the machines R1 and R2 included in at least one cell 40.

The learning unit 13 includes a learning model for learning different production data. The learning unit 13 includes an error calculation unit 15, which calculates an error between the production result acquired by the operation result acquisition unit 12, e.g., the number of products, the various qualities of products, etc. and a predetermined target, and a learning model update unit 16 for updating the leaning model according to the error.

When products are produced based on given production data, if the quality of the products, which is received as one of outputs from the operation result acquisition unit 12, exceeds a predetermined threshold value, the error calculation unit 15 outputs a calculation result indicating that a predetermined error occurs in the production result of the production data. Further, the learning model update unit 16 updates the learning model in accordance with the calculation result.

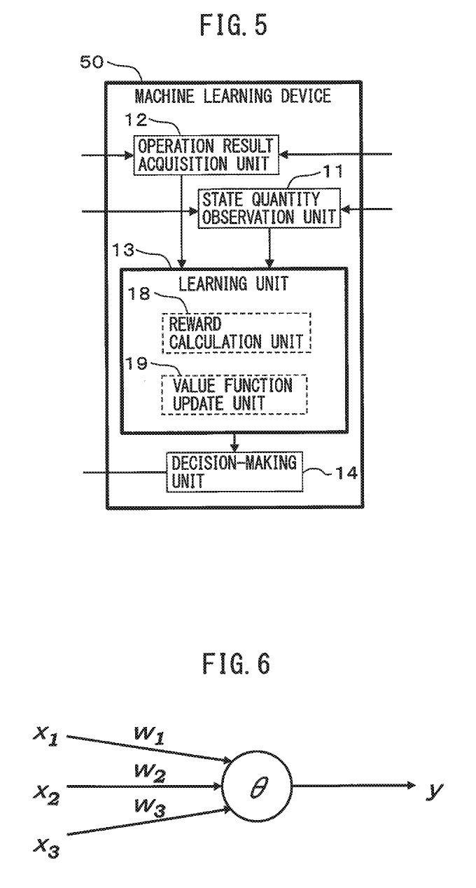

FIG. 5 is a view of another example of the machine learning device. The learning unit 13 shown in FIG. 5 includes a reward calculation unit 18 and a value function update unit 19 for updating a value function in accordance with a reward. The machine learning device 50 shown in FIG. 5 does not include a result (label) attached data recording unit 17. Depending on the contents of the production result of a product, different value functions for determining the value of the production data are provided for the corresponding production data.

The reward calculation unit 18 provides a plus reward according to the magnitude of a difference when the difference between the quality of products acquired by the operation result acquisition unit 12 and a target quality is small, and provides a minus reward according to the magnitude of a difference when the difference is large.

In this instance, when products are produced based on given production data, if the quality of the products, which is received as one of outputs from the operation result acquisition unit 12, exceeds a predetermined threshold value, it is preferable that the reward calculation unit 18 provides a predetermined minus reward, and the value function update unit 19 updates a value function according to the predetermined minus reward.

Finally, a learning method of the machine learning device 50 will be described. The machine learning device 50 has a function for extracting, for example, a useful algorithm, a rule, a knowledge expression, a criterion, etc. in a set of data input thereto by analysis, outputting a determination result, and learning knowledge.

Examples of machine learning include algorithms, such as supervised learning, unsupervised learning, and reinforcement learning. In order to achieve these leaning methods, there is another method referred to as “deep learning” for learning extraction of feature quantity itself.

Supervised learning is a method in which a large volume of input-output (label) paired data are given to the machine learning device 50, so that characteristics of these datasets can be learned, and a model for inferring an output value from input data, i.e., the input-output relation can be inductively acquired. In the supervised learning, input-output paired data appropriate for learning are given, so that learning is relatively easily facilitated.

Unsupervised learning is a method in which a large volume of input-only data are given to a learning apparatus, so that the distribution of the input data can be learned, and leaning is performed by a device for, for example, compressing, classifying, and fairing the input data even if the corresponding teacher output data are not given. This method is different from the supervised learning in that “what to be output” is not previously determined. This method is used to extract the essential structure behind the data.

Reinforcement learning is a learning method for learning not only determinations or classifications but also actions, to learn an appropriate action based on the interaction of environment to an action, i.e., an action to maximize rewards to be obtained in the future. In the reinforcement learning, learning is started from a state where a result of an action is totally unknown or known only incompletely. However, the reinforcement learning can be started from a starting point having good conditions, i.e., the state, in which the pre-learning is carried out by the supervised learning, set as an initial state. The reinforcement learning has characteristics in which an action for discovering unknown learning areas and an action for utilizing known learning areas can be selected with good balance. Thus, there is a possibility that appropriate target production conditions may be further found in condition areas which have been conventionally unknown. Further, outputting of production data causes the temperature etc. of machines or products to change, i.e., an action exerts an effect to the environment. Thus, adopting of the reinforcement learning is seemingly meaningful.

FIG. 4 illustrates an example of the machine learning device 50 for supervised learning. FIG. 5 illustrates an example of the machine learning device 50 for reinforcement learning.

First, a learning method using supervised learning will be described. In the supervised learning, a pair of input data and output data appropriate for learning is provided, and a function (learning model) for mapping input data and output data corresponding thereto is generated.

An operation of the machine learning apparatus that performs the supervised learning includes two stages, i.e., a learning stage and a prediction stage. At the learning stage, when supervising data including a value of a state variable (explanation variable) used as input data and a value of a target variable used as output data are provided, the machine learning apparatus, which performs the supervised learning, learns outputting of the value of the target variable at the time of inputting of the value of the state variable, and constructs a prediction model for outputting the value of the target variable with respect to the value of the state variable. Then, at the prediction stage, when new input data (state variable) is provided, the machine learning apparatus, which performs the supervised learning, predicts and outputs output data (target variable) according to the learning result (constructed prediction model). In this respect, the result (label) attached data recording unit 17 can hold the result (label) attached data obtained thus far, and provide the result (label) attached data to the error calculation unit 15. Alternatively, the result (label) attached data of the cell control device 30 can be provided to the error calculation unit 15 of the cell control device 30 through a memory card, a communication line, etc.

As an example of learning of the machine learning apparatus that performs the supervised learning, a regression formula of a prediction model similar to, for example, that of following equation (1) is set, and learning proceeds to adjust values of factors a₀, a₁, a₂, a₃, . . . so as to obtain a value of a target variable y when values taken by state variables x₁, x₂, x₃, . . . during the learning process are applied to the regression formula. Note that the learning method is not limited to this method, and varies from one supervised learning algorithm to another.

y=a₀+a₁x₁+a₂x₂+a₃x₃+ . . . +aₙxₙ

As supervised learning algorithms, there are known various methods such as a neural network, a least squares method, and a stepwise method, and any of these supervised learning algorithms may be employed as a method applied to the present invention. Each supervised learning algorithm is known, and accordingly, detailed description thereof is omitted herein.

Subsequently, a learning method using reinforcement learning will be described. Problems of the reinforcement learning may be set as follows.
The learning unit 13 observes a state of an environment including a state of the cell 40, to decide an action (outputting of production data).
The environment changes according to a certain algorithm, and the action may give a change to the environment.
A reward signal is returned for each action.
It is the sum of rewards in the future that is desired to be maximized.
Learning is started from a state where a result caused by the action is totally unknown or known only incompletely.

As representative reinforcement learning methods, Q learning and TD learning are known. Hereinafter, the case of the Q learning will be described, but a method is not limited to the Q learning.

The Q learning is a method for learning a value Q (s, a) for selecting an action a under a given environment state s. In the state s, an action a of a highest value Q (s, a) may be selected as an optimal action. However, at first, as a correct value of the value Q (s, a) is not known for a combination of the state s with the action a, an agent (action subject) selects various actions a under the state s, and is given rewards for the actions a at the time. This way, the agent selects a better action, in other words, learns a correct value Q (s, a).

Further, with a view to maximizing the sum of rewards obtained in the future as a result of the action, Q (s, a)=E[Σ(γ^{c})rₜ] may be finally achieved. E[ ] represents an expected value, t represents time, γ represents a parameter referred to as a discount rate described below, rₜ represents a reward at the time t, and Σ represents the sum at the time t. The expected value in this formula is taken when a state changes according to the optimal action, and learned through searching as it is not known. An update formula for such a value Q (s, a) can, for example, be represented by equation (2) described below.

In other words, the value function update unit 16 updates a value function Q (sₜ, aₜ) by using the following equation (2):

$$Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) )$$

where, sₜ represents a state of the environment at the time t, and aₜ represents an action at the time t. The action aₜ changes the state to sₜ₊₁. rₜ₊₁ represents a reward that can be obtained via the change of the state. Further, a term with max is a Q value multiplied by γ for a case where the action a for the highest Q value known at that time is selected under the state sₜ₊₁. γ is a parameter of 0<γ≦1, and referred to as a discount rate. α is a learning factor, which is in the range of 0<α≦1.

The equation (2) represents a method for updating an evaluation value Q (sₜ, aₜ) of the action at in the state sₜ on the basis of the reward rₜ₊₁ returned as a result of the action aₜ. It indicates that when the sum of the reward rₜ₊₁ and an evaluation value Q (sₜ₊₁, max aₜ₊₁) of the best action max a in the next state based on the action a is greater than the evaluation value Q (sₜ, aₜ) of the action a in the state s, Q (sₜ, aₜ) is increased, whereas when less, Q (sₜ, aₜ) is decreased. In other words, it is configured such that the value of some action in some state is made to be closer to the reward that instantly comes back as a result and to the value of the best action in the next state based on that action.

Methods of representing Q (s, a) on a computer include a method in which the value is retained as an action value table for all state-action pairs (s, a) and a method in which a function approximate to Q (s, a) is prepared. In the latter method, the abovementioned equation (2) can be implemented by adjusting parameters of the approximation function by a technique, such as stochastic gradient descent method. The approximation function may use a neural network.

As described above, as the learning algorithm of the supervised learning or the approximation algorithm of the value function in the reinforcement learning, the neural network can be used. Thus, the machine learning device 50 preferably has the neural network.

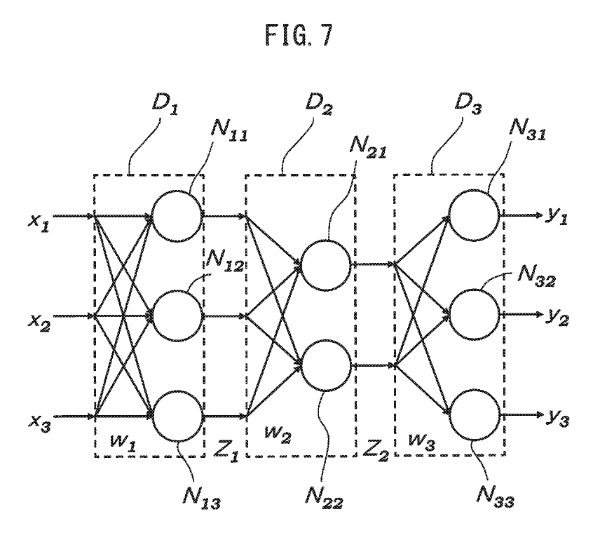

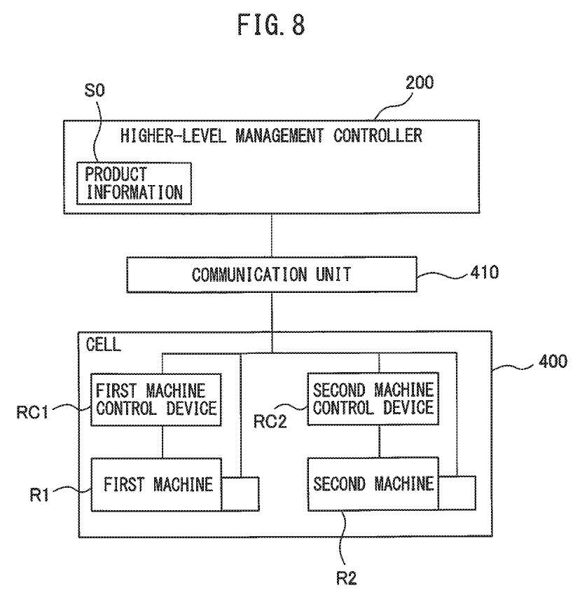

FIG. 6 schematically illustrates a neuron model, and FIG. 7 schematically illustrates a three-layer neural network configured by combining neurons illustrated in FIG. 6. The neural network includes an arithmetic unit, a memory, or the like that imitates a neuron model such as that illustrated in FIG. 6. The neuron outputs an output (result) y for a plurality of inputs x. Each input x (x₁ to x₃) is multiplied by a weight w (w₁ to w₃) corresponding to the input x. The neuron outputs the output y represented by following equation (3). The input x, the output y, and the weight w all are vectors.

$$y = {f}_{k} ( {\sum }_{i = 1}^{n} {X}_{i} {W}_{i} - θ )$$

where θ is a bias, and fₖ is an activation function.

As illustrated in FIG. 7, a plurality of inputs x (x₁ to x₃) is input from the left side of the neural network, and a result y (γ₁ to γ₃) is output from the right side. The inputs x₁ to x₃ are multiplied by corresponding weights and input to the three neurons N₁₁ to N₁₃. The weights applied to these inputs are collectively indicated by w₁.

The neurons N₁₁ to N₁₃ output z₁₁ to z₁₃, respectively. In FIG. 7, z₁₁ to z₁₃ are collectively represented as a feature vector z₁, and can be regarded as a vector obtained by extracting the feature amounts of the input vector. The feature vector z₁ is a feature vector between the weight w₁ and the weight w₂. The feature vectors z₁₁ to z₁₃ are multiplied by a corresponding weight and input to each of the two neurons N₂₁ and N₂₂. The weights applied to these feature vectors are collectively represented as w₂. The neurons N₂₁ and N₂₂ output z₂₁ and z₂₂, respectively. In FIG. 7, z₂₁ and z₂₂ are collectively represented as a feature vector z₂. The feature vector z₂ is a feature vector between the weight w₂ and the weight w₃. The feature vectors z₂₁ and z₂₂ are multiplied by a corresponding weight and input to each of the three neurons N₃₁ to N₃₃. The weights multiplied to these feature vectors are collectively represented as w₃.

Finally, the neurons N₃₁ to N₃₃ output results y₁ to y₃, respectively. An operation of the neural network includes a learning mode and a value prediction mode: in the learning mode, the weight w is learned by using a learning data set, and in the prediction mode, an action of outputting production data is determined by using parameters thereof. Here, the apparatus can be actually operated in the prediction mode to output the production data and instantly learn and cause the resulting data to be reflected in the subsequent action (on-line learning), and a group of pre-collected data can be used to perform collective learning and implement a detection mode with the parameter subsequently for quite a while (batch learning). An intermediate case is also possible, where a learning mode is introduced each time data is accumulated to a certain degree.

The weights w₁ to w₃ can be learned by an error backpropagation method. Error information enters from the right side and flows to the left side. The error backpropagation method is a technique for adjusting (learning) each weight so as to minimize a difference between an output y when an input x is input and a true output y (teacher) for each neuron.

The number of intermediate layers (hidden layers) of the neural network illustrated in FIG. 7 is one. However, the neural network can increase the layers to two or more, and when the number of intermediate layers is two or more, it is referred to as deep learning.

The application of the reinforcement learning and the supervised learning has been described. However, the machine learning method applied to the present invention is not limited to these methods. Various methods such as “supervised learning”, “unsupervised learning”, and “half-supervised learning”, and “reinforcement learning” usable in the machine learning device 10 can be applied.

The machine learning device 50 described above performs learning based on the information from the product information monitoring unit 31, the component supply state monitoring unit 32, and the product monitoring unit 33, to estimate the required number of the plural kinds of the components A to C per product to be produced. The number N1 of products which can be produced in the cell 40 is calculated from the estimated values for the components A to C, and then is compared with the number N2 of products actually produced. As in the description above, for example, which one of the machines R1 and R2 breaks down can be estimated.

Further, the machine learning device 50 learns the time sift of the numbers NA1, NB1, and NC1 of the plural kinds of the components A to C from the component supply state monitoring unit 32 and the number N2 of products from the product monitoring unit 33, to estimate the state of the cell 40. When the components A to C supplied to the cell 40 are exhausted, the fact that the supply of products is halted is estimated. When the number of the supplied products is enough, but the number N2 of products actually produced is small, an estimation in which, for example, any of the machines R1 and R2 breaks down can be obtained.

The machine learning device 50 has an excellent real-time property, and a local supervision area, and accordingly, can improve the accuracy of detection of the abnormality described above.

Note that, in the production system 10 in the above embodiments, as shown in FIG. 1, one machine learning device 50 is provided in one production system 10. However, in the present invention, the number of the production system 10 and the machine learning device 50 is not limited to one. It is preferable that a plurality of production systems 10 are provided, and a plurality of machine learning devices 50 each provided in the corresponding one of the production systems 10 share or exchange data. Sharing of data including learning results acquired by each production system 10 enables an accurate learning effect to be acquired in a shorter time, and enables more appropriate production data to be output.

Furthermore, the machine learning device 50 may be located inside or outside the production system 10. Alternatively, a plurality of production systems 10 may share a single machine learning device 50 via communication media. Alternatively, the machine learning device 50 may be located on a cloud server.

Consequently, it is possible to share the learning effect as well as to collectively manage data and perform learning using a large high-performance processor. Thus, the learning speed and learning accuracy can be improved, and more appropriate production data can be output. Further, the time necessary to decide production data to be output can be reduced. A general-purpose computer or processor can be used for these machine learning devices 50. However, when, for example, general-purpose computing on graphics processing units (GPGPU) or large PC clusters are applied, processing can be performed at a higher speed.

Effect of the Invention

In the first aspect of the invention, when the number of each kind of components deviates from a predetermined range, it can be determined that at least one of the plural kinds of components to be supplied to the cell is too much or not enough. Thus, the higher-level management controller receives a notice, and appropriately changes the number of components which are too much or not enough, whereby the production system can be efficiently operated.

In the second aspect of the invention, the number of products to be produced in the cell is determined in accordance with the number of plural kinds of products to be supplied to the cell. When the number of products to be produced in the cell is less than the number of products which are monitored by the product monitoring unit and which are actually produced, it can be determined that at least one of the machines in the cell breaks down. Thus, the higher-level management controller receives this information, and reduces the number of the plural kinds of products by the same ratio, whereby the production system can be efficiently operated.

In the third aspect of the invention, even if the number of products to be produced in the cell is equal to the number of products which are monitored by the product monitoring unit and which are actually produced, when the number of products to be produced in the cell is less than the desired number of products, it can be determined that the number of plural kinds of components to be supplied to the cell is not enough. Thus, the higher-level management controller receives this information, and increases the number of plural kinds of components, whereby the production system can be efficiently operated.

In the fourth to eighth aspects of the invention, the accuracy in detection of an abnormality in the production system can be improved.

The present invention has been described above using exemplary embodiments. However, a person skilled in the art would understand that the aforementioned modifications and various other modifications, omissions, and additions can be made without departing from the scope of the present invention.

What is claimed is:

1. A production system comprising:
at least one cell including a plurality of machines for producing products, and a plurality of machine control devices for controlling the plurality of machines;
a cell control device which is communicably connected to the at least one cell, to control the cell; and
a higher-level management controller which is communicably connected to the cell control device and which includes product information, wherein
the product information includes plural kinds of components to produce each product and the number of each kind of components,
the cell control device includes:
a product information monitoring unit for monitoring the product information;
a component supply state monitoring unit for monitoring the plural kinds of components to be supplied to the at least one cell and the number of each kind of components; and
a notification unit which transmits a notice to the higher-level management controller when the number of each kind of components, which is monitored by the component supply state monitoring unit, deviates from a predetermined range determined for each kind of components.

2. The production system according to claim 1, wherein
the cell control device includes a product monitoring unit for monitoring the number of the products actually produced in the cell,
when the number of the products to be produced in the cell, which is determined in accordance with the number of the plural kinds of components and each kind of components, which are monitored by the component supply state monitoring unit, is less than the number of the products which are monitored by the product monitoring unit and which are actually produced in the cell, the notification unit transmits a notice to the higher-level management controller.

3. The production system according to claim 1, wherein
the cell control device includes a product monitoring unit for monitoring the number of the products actually produced in the cell, and
when the number of the products to be produced in the cell, which is determined in accordance with the number of the plural kinds of components and each kind of components, which are monitored by the component supply state monitoring unit, is equal to the number of the products which are monitored by the product monitoring unit and which are actually produced in the cell, and the number of the products to be produced in the cell is less than the desired number of the products, the notification unit transmits a notice to the higher-level management controller.

4. The production system according to claim 1, wherein
the production system comprises a machine learning device for learning production data of the production system, and
the machine learning device comprises:
a state quantity observation unit for observing the state quantity of the production system;
an operation result acquisition unit for acquiring a production result of each product in the production system;
a learning unit which receives an output from the state quantity observation unit and an output from the operation result acquisition unit, to learn the production data in association with the state quantity of the production system and the production result; and
a decision-making unit which outputs production data with reference to the production data learned by the machine learning device.

5. The production system according to claim 4, wherein
the cell control device includes a product monitoring unit for monitoring the number of the products actually produced in the cell, and
the state quantity observed by the state quantity observation unit includes at least one of the desired number of products, the product information monitored by the product information monitoring unit, the number of the plural kinds of components and each kind of components monitored by the component supply state monitoring unit, the number of the products which are monitored by the product monitoring unit and which are actually produced, and settings for the plurality of machines included in the cell.

6. The production system according to claim 4, wherein the production data output by the decision-making unit includes at least one of the number of each kind of components to be supplied to the at least one cell and the settings for the plurality of machines included in the at least one cell.

7. The machine learning device according to claim 4, wherein
the machine learning device includes a learning model for learning production data, and comprises:
an error calculation unit for calculating an error between the production result acquired by the operation result acquisition unit and a predetermined target; and
a learning model update unit for updating the learning model in accordance with the error.

8. The machine learning device according to claim 4, wherein
the machine learning device has a value function for determining the value of production data, and
the machine learning device further comprises:
a reward calculation unit which provides a plus reward in accordance with a difference between the production result acquired by the operation result acquisition unit and a predetermined target when the difference is small, and provides a minus reward in accordance with the difference when the difference is large; and
a value function update unit for updating the value function in accordance with the reward.
